(19) United States
(12) Patent Application Publication
(10) Pub. No.: US 2008/0067012 A1
(43) Pub. Date: Mar. 20, 2008

(54) Brake Assembly for In-Vehicle Platform Lift

(76) Inventor: Michael D. Kobrehel, Elkhart, IN (US)

Correspondence Address: QUARLES & BRADY LLP, 411 E. WISCONSIN AVENUE, SUITE 2040, MILWAUKEE, WI, 53202-4497, US

(21) Appl. No.: 11/855,517

(22) Filed: Sep. 14, 2007

Related U.S. Application Data
(60) Provisional application No. 60/825,817, filed on Sep. 15, 2006.

(51) Int. Cl. B66B 5/18

(52) U.S. Cl. 187/377

(57) ABSTRACT

A brake assembly for an in-vehicle platform lift including at least one column and at least one flexible drive member. The brake assembly has at least one lever including a brake face that engages the column to brake the platform lift when the flexible drive member goes slack. The brake assembly is biased into the brake position and can be configured to brake the platform lift when the flexible drive member is stationary.

### CROSS-REFERENCE TO RELATED APPLICATIONS

This claims the benefit of U.S. Provisional Application No. 60/825,817 filed Sep. 15, 2006, the disclosure of which is hereby incorporated by reference.

### STATEMENT REGARDING FEDERALLY SPONSORED RESEARCH

Not applicable.

### BACKGROUND OF THE INVENTION

The present invention relates to recreational vehicles, and more particularly to safety devices for lifting mechanisms for raising and lowering objects within the interiors of such vehicles.

A way to increase interior space in such vehicles is to change the vertical position of certain objects at the vehicle interior, such as furniture and other such items. The objects can be raised out of the way when not used, but otherwise lowered while being used. This allows floor space and living space to be cleared of unnecessary objects without eliminating the presence of those objects from within the vehicle.

In-vehicle lift mechanisms of the type that are mounted within the interior of a trailer or other vehicle for raising and lowering a platform are known. International Patent Application Publication No. WO2006/007522 describes one such lift mechanism, which is specially suited for raising and lowering furniture such as a bunk bed. U.S. patent application Ser. No. 11/771,619 filed Jun. 29, 2007 describes another such lift mechanism, which is specially suited for raising and lowering heavy loads. These applications are hereby incorporated by reference as if fully set forth herein for their disclosures of lift mechanisms.

In-vehicle lift mechanisms typically employ cables or other suitable linearly flexible material to raise and lower the platform. The cables are driven up and down by a motor that pulls or lets out the cables or pushes a support or suspension member that can be pushed to transfer force. The motor can include a motor brake that engages the motor when the motor is not in motion, the motor brake holding the platform in position. Unfortunately, the cables or other suitable linearly flexible structure can break or the motor brake can fail thereby causing the platform to fall. Safety devices for in-vehicle lift mechanisms can prevent the platform from falling when a failure occurs, and a need exists for such a device that does not add substantial cost, weight, or size to a platform lift.

### SUMMARY OF THE INVENTION

The invention provides a brake assembly for a platform lift for a vehicle, the platform lift having at least one platform assembly suspended by at least one flexible drive member and guided by at least one column, the platform assembly being movable vertically up and down by moving the flexible drive member. A lever is pivotally attached to the platform assembly that is pivotable about a pivot axis and is connected to the at least one flexible drive member so that tension on the flexible drive member rotates the lever about the pivot axis into a disengaged position. A spring biases the lever away from the disengaged position toward an engaged position if tension is relieved from the flexible drive member. A brake is connected to the platform assembly so as to move up and down with the platform assembly and configured to engage the column when actuated and to disengage the column when de-actuated. The brake cooperates with the lever so as to be disengaged in the disengaged position of the lever and engaged with the column in the engaged position of the lever.

The brake can be positioned at an end of the lever or can be cam operated by the lever. In addition, the brake can be a friction brake that presses against a surface of the column or a ratchet brake that arrests downward movement of the platform assembly when at least one tooth of the lever engages a mating element of the column.

In another aspect, the present invention provides a brake assembly for a platform lift for a vehicle, the platform lift comprising at least one platform assembly suspended by at least one flexible drive member and guided by at least one column having a channel with a channel face, the platform being movable vertically, the brake assembly comprising a plate attached to the platform assembly and positioned within the channel, a lever pivotally attached to the plate, the lever pivotable about a pivot axis and having a first lever arm and a second lever arm disposed on opposite sides of the pivot axis, a coupling mount attached to the first lever arm and connected to the at least one flexible drive member, a stop pin attached to the plate configured to engage the lever when the lever is rotated by a force provided by the at least one flexible drive member, the lever transmitting the force to the platform assembly when the lever engages the stop pin, a brake face disposed on an end of the second lever arm, and a spring attached between the plate and the first lever arm, the spring configured to rotate the lever so as to force the brake face against the channel face thereby providing a braking force when the at least one flexible drive member is slack.

In another aspect, the present invention provides a brake assembly for a platform lift for a vehicle, the platform lift comprising at least one platform assembly suspended by at least one flexible drive member and guided by at least one column having a channel with a channel first face, the platform assembly being movable vertically, the brake assembly comprising a plate attached to the platform assembly and positioned within the channel, a first lever pivotally attached to the plate, the first lever pivotable about a first lever pivot axis and having a first lever arm and a second lever arm disposed on opposite sides of the first lever pivot axis, a second lever pivotally attached to the plate, the second lever pivotable about a second lever pivot axis and having a third lever arm, and a fourth lever arm disposed on opposite sides of the second lever pivot axis, a first coupling mount attached to the first lever arm and connected to the at least one flexible drive member, a first brake face disposed on an end of the fourth lever arm, a spring attached between the plate and the third lever arm, the spring configured to rotate the second lever so as to force the second lever into engagement with the first lever thereby rotating the first lever and further configured to force the first brake face against the channel first face thereby providing a braking force when the at least one flexible drive member is slack, and a first stop pin attached to the plate configured to engage the first lever when the first lever is rotated by a drive member force provided by the at least one flexible drive member, the first lever causing the second lever to rotate so as to move the first brake face away from the channel first face, and the first lever transmitting the drive member force to the platform assembly through the first stop pin and plate when the first lever is in engagement with the first stop pin.

These and other aspects of the invention will be apparent to persons of ordinary skill in the art from the detailed description and drawings.

### BRIEF DESCRIPTION OF THE DRAWINGS

FIG. 1 is a perspective view of a platform lift including a brake assembly;

FIG. 2 is a perspective view of a brake assembly of a platform lift with a portion of the column cutaway to illustrate the brake assembly in a locked state;

FIG. 3 is a sectional view of the brake assembly of FIG. 2;

FIG. 4 is a sectional view of an alternate brake assembly;

FIG. 5 is a sectional view of an alternate brake assembly;

FIG. 6 is a sectional view of an alternate brake assembly;

FIG. 7 is a perspective view of a lever having a brake face;

FIG. 8 is a perspective view of a lever having an alternate brake face;

FIG. 9A is a perspective view of a lever having an alternate brake face;

FIG. 9B is a front view of a mating element configured to be engaged by the brake face of FIG. 9A;

FIG. 11 is a perspective view of a lever having an alternate brake face and a mating element configured to be engaged by the brake face; and

FIG. 12 is a sectional view of an alternate brake assembly.

### DETAILED DESCRIPTION OF THE PREFERRED EMBODIMENT

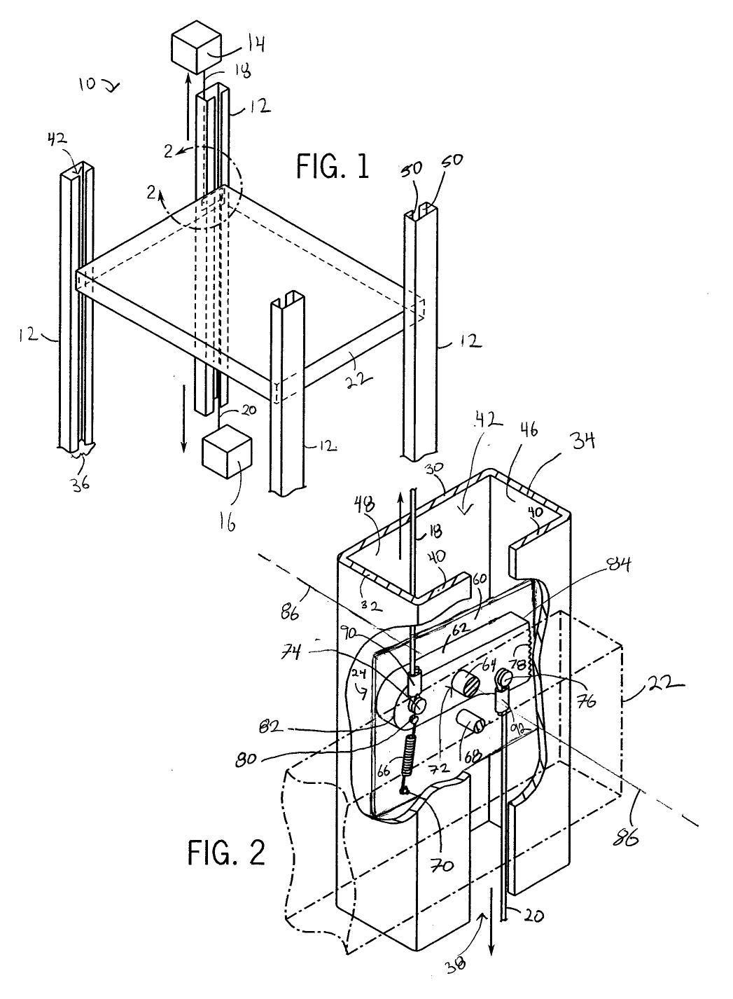

Although not shown in the drawings, the present invention is preferably used in a vehicle, such as a tow-along trailer or self-propelled (motorhome) recreational vehicle. Referring now to the drawings wherein like reference numbers correspond to similar components throughout the several views and, specifically, referring to FIG. 1, the present invention shall be described in the context of a platform lift 10. Platform lift 10 includes columns 12, a first motor assembly 14, a second motor assembly 16, a first flexible drive member 18, a second flexible drive member 20, a platform assembly 22 and brake assembly 24. To simplify the description, FIG. 1 shows only one column 12 having motor assemblies and drive members; however, platform lift 10 can include a plurality of columns each having at least one motor assembly and at least one flexible drive member. As is known in the art, columns 12 are mounted to a vehicle. Flexible drive members 18 and 20 are each attached to a spool (not shown) of motor assemblies 14 and 16, respectively. Flexible drive members 18 and 20 can be wound and unwound on the spools by motor assemblies 14 and 16. Flexible drive members 18 and 20 can comprise a cable, chain, elastomeric drive tape or other suitable linearly flexible material.

Referring now to FIG. 2, columns 12 are rectangular tubes including a back wall 30, a first side wall 32, a second side wall 34, and a front wall 36 with an opening 38 formed therein thereby defining two rails 40. Back wall 30 and front wall 36 are parallel to each other and are wider than side walls 32 and 34. A channel 42 with a rectangular cross section is defined within each of the columns 12, channel 34 defined by wall 30, wall 32, wall 34 and rails 40. Channels 42 each have a first side face 44, a second side face 46, a back face 48 and a pair of rail channel faces 50. First side face 44 is formed on the inside of first side wall 32 (shown in FIG. 3), second side face 46 is formed on the inside of second side wall 34, back face 48 is formed on the inside of back wall 30, and rail channel faces 50 are formed on the inside rails 40 (shown in FIG. 1).

FIG. 2 shows brake assembly 24 in a locked state. Brake assembly 24 includes a plate 60, a lever 62, a pivot pin 64, a spring 66, and a stop pin 68. Plate 60 is generally rectangular and includes a spring mount 70. Lever 62 includes a pivot opening 72, a first coupling pin 74, a second coupling pin 76, a brake face 78 and a spring mount 80. Pivot opening 72 is generally disposed in a mid-portion of lever 62 so that lever 62 includes a first lever arm 82 and a second lever arm 84 on opposite sides of pivot opening 72. First coupling pin 74 is attached to first lever arm 82. Second coupling pin 76 is attached to second lever arm 84. Spring mount 78 is attached to first lever arm 82 below first coupling pin 74. Brake face 78 is disposed on the end of second lever arm 84.

Still referring to FIG. 2, plate 60 is positioned within channel 42, lever 62 is positioned within channel 42 and platform assembly 22 is positioned outside of column 12. Plate 60 is parallel to back face 49 of column 12. Lever 62 is positioned between plate 60 and rails 40 of column 12. Pivot pin 64 is fixedly attached to plate 60 and to platform assembly 22. A portion of pivot pin 64 is positioned within opening 38 of column 12. Stop pin 68 is fixedly attached to plate 60 and to platform assembly 22. Alternatively, pivot pin 64 and stop pin 68 can extend from one of plate 60 and platform assembly 22, and attach to the other of plate 60 and platform assembly 22. Stop pin 68 can also be connected to one of plate 60 and platform assembly 22. A portion of stop pin 68 is positioned within opening 38 of column 12. Plate 60 can not rotate in relation to platform assembly 22 or column 12. Pivot pin 64 extends through pivot opening 72 of lever 62 so that lever 62 can pivot about a pivot axis 86. Pivot axis 86 is parallel to the axis of stop pin 68. Stop pin 68 is attached to plate 60 at a position that is below where pivot pin 64 is attached and is below second lever arm 84. Lever 62 can be pivoted into engagement with stop pin 68. First lever arm 82 can be narrower than the end of second lever arm 84. Second lever arm 84 can have width near pivot opening 72 that is equal to a width of first lever arm 82 near pivot opening 72, second lever arm 84 widening along a bottom portion including a portion where lever 62 engages stop pin 68.

First flexible drive member 18 includes a platform end 90 that is attached to first coupling pin 74 of lever 62. Second flexible drive member 20 includes platform end 92 that is attached to second coupling pin 76. Spring mount 70 is attached to plate 60 at a position that is below where pivot pin 64 is attached to plate 60 and is below first lever arm 82. Spring 66 is an extension spring that extends between spring mount 70 of plate 60 and spring mount 78 of lever 62. Spring 66 exerts a force on first lever arm 82, the force of spring 66 having a moment that causes lever 62 to rotate away from stop pin 68 in a counterclockwise direction (as shown in the Figs.) when no forces act on coupling pins 74 and 76 (e.g., when flexible drive members 18 and 20 are slack). Spring 66 can cause lever 62 to rotate until a portion of brake face 78 engages second side face 46 of column 12. At least a top portion of brake face 78 is angled so that brake face 78 can be rotated into engagement with second side face 46. The interaction between brake face 78 and second side face 46 prevent lever 62 from further rotation. Spring 66 can provide sufficient force to place the brake face 78 against second side face 46. When brake face 78 engages, bites or attaches to second side face 46 (i.e., when the brake assembly 24 is in the locked state) and a force is applied to pivot pin 64, friction and/or some other mechanical interaction between brake face 78 and second side face 46 prevent pivot pin 64, and thus platform assembly 22, from moving downward. In this locked state, the lever 62 is substantially horizontal.

Motor assemblies 14 and 16 can raise and lower platform ends 90 and 92 to provide a force on first coupling pin 74 and a force on second coupling pin 76. Motor assemblies 14 and 16 can also be locked to prevent movement of platform ends 90 and 92. When platform ends 90 and 92 are stationary and the flexible drive members 18 and 20 are taught, flexible drive member 18 exerts a tension force on first lever arm 82 because first coupling pin 74 is stationary and gravity is pulling down the lever 62 and platform assembly 22. Additionally, at all times, the tension on flexible drive member 18 can exert a tension force on first lever arm 82 and the tension on flexible drive member 20 can exert a tension force on second lever arm 84. The moment of a force on first lever arm 82 can overcome the moment of the force of spring 66 on first lever arm 82 thereby causing the lever 62 to rotate in a clockwise direction (as shown in the Figs.) until lever 62 contacts stop pin 68. When lever 62 is in contact with stop pin 68, the brake assembly 24 is unlocked and a force on first coupling pin 74 is transmitted to pivot pin 64 and platform assembly 22 so that platform assembly 22 can be raised. The moment of a force on second lever arm 84 can overcome the moment of the force of spring 66 on first lever arm 82 thereby causing the lever to rotate in a clockwise direction (as shown in the Figs.) until lever 62 contacts stop pin 62. When lever 62 is in contact with stop pin 68, the brake assembly 24 is unlocked and a force on second coupling pin 76 is transmitted to pivot pin 64 and platform assembly 22 so that platform assembly 22 can be lowered. The brake assembly 24 can operate in a similar manner with an endless flexible member system (e.g., a chain).

The spring 66 can be sized so that brake assembly 24 becomes locked only when both drive members 18 and 20 go slack, which means that the spring 66 does not overcome the moments of the tension forces of flexible drive members 18 and 20 when flexible drive members 18 and 20 are stationary. The spring 66 can bias the brake assembly 24 into the locked state so that when flexible drive members 18 and 20 go slack (e.g., if drive member 18 breaks and platform assembly 22 falls so that flexible drive member 20 also goes slack), the brake assembly 24 goes into the locked state and prevents the platform assembly 22 from falling. The spring 66 can be similarly sized for a platform system with only one flexible member per column (i.e., brake assembly 24 becomes locked when the flexible member goes slack, but does not become locked when the system is stationary). A slack sensor on the flexible drive member 18 can be used to shut off the motor assemblies 14 and 16 when flexible drive member 18 goes slack so that motor assembly 16 can not provide tension on flexible drive member 20 to allow flexible drive member 20 to go slack in order for the brake assembly 24 to become locked. Alternatively, the spring 66 can be sized to overcome the moments of the tension forces of flexible drive members 18 and 20 when flexible drive members 18 and 20 are stationary, which means that the brake assembly 24 becomes unlocked only when flexible drive members 18 and 20 are moved by motor assemblies 14 and 16.

Referring now to FIG. 3, brake assembly 24 can include stop pins in addition to stop pin 68. For example, a stop pin 100 is fixedly attached to and/or extends from plate 60 and platform assembly 22 or one of plate 60 and platform assembly 22. Stop pin 100 is positioned above first pivot arm 82. Lever 62 can be pivoted into engagement with stop pin 100 when the force of spring 66 is overcome, lever 62 engaging pivot pin 68 when stop pin 100 is engaged. A portion of stop pin 68 can be positioned within opening 38 of column 12.

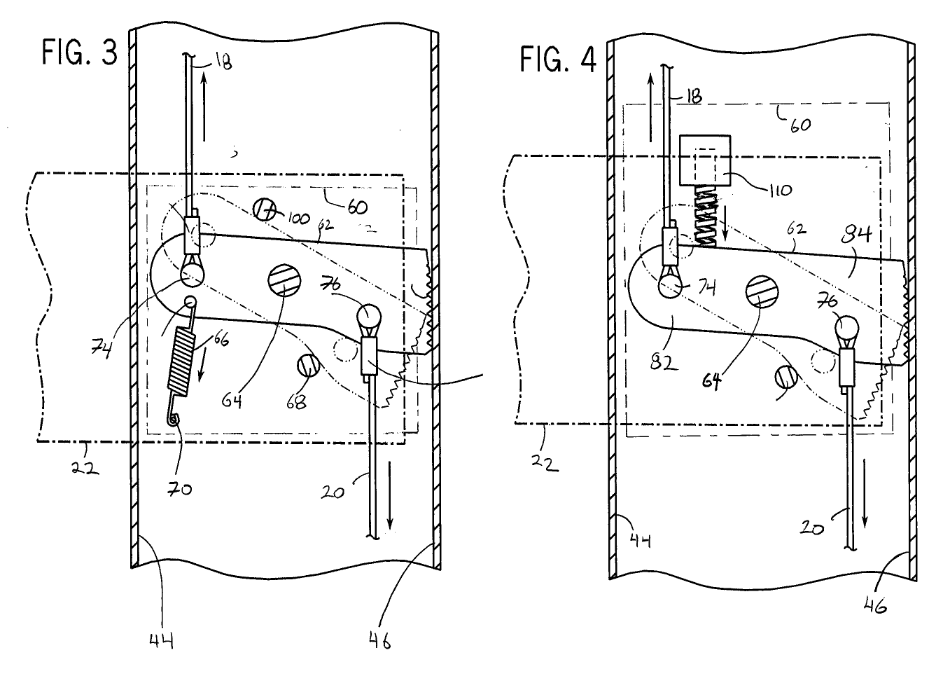

Referring now to FIG. 4, brake assembly 24 can include a spring 110. Spring 110 is a compression spring mounted to plate 60 above first lever arm 82. An end of spring 110 engages a top side of first lever arm 82. Spring 110 exerts a force on first lever arm 82, the moment of this force similar to the moment of the force of spring 66 so that brake assembly 24 operates in a similar manner. Other similar springs or elastomeric materials can be used to bias the brake assembly 24 into the locked position.

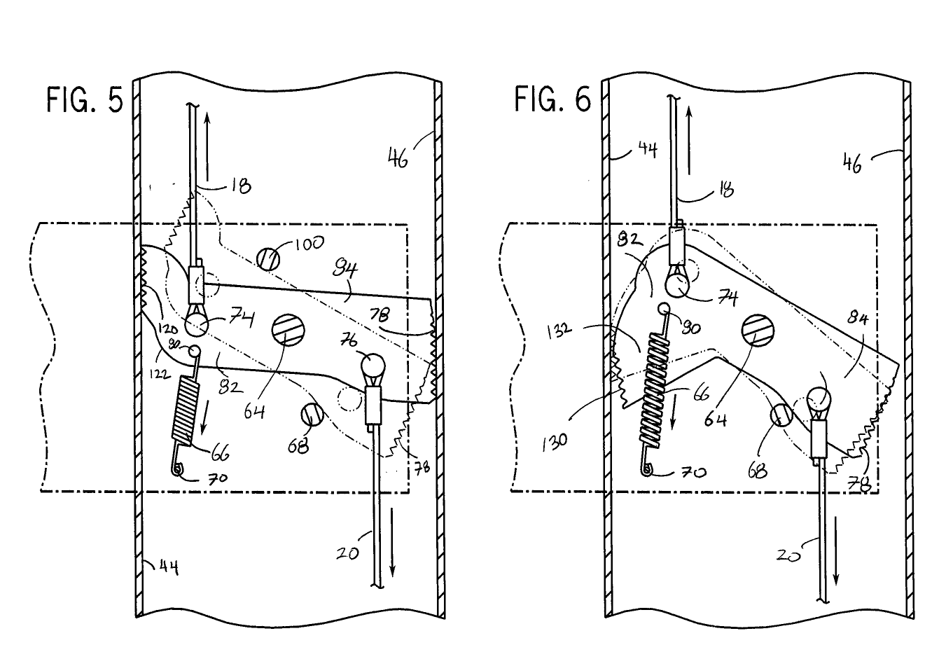

Referring now to FIG. 5, lever 62 can include a brake face 120 in addition to brake face 78 that enhances the stopping force of brake assembly 24. Brake face 120 is disposed on the end of first lever arm 82. First lever arm 82 is configured so that brake face 120 engages first side face 44 of column 12 when brake face 68 engages second side face 46 of column 12. Therefore, brake face 120 provides additional surface area to achieve a greater locking force (e.g., friction or other mechanical interaction) when the brake assembly 24 is locked. First lever arm 82 can include a curved portion 122 that curves upward to brake face 120 so that curved portion 122 is disposed above a portion of first lever arm adjacent pivot opening 72 in the locked position and so that at least a portion of brake face 120 is disposed above brake face 68 in the locked position. Brake face 120 does not engage first side face 44 when brake assembly 24 is unlocked.

Referring now to FIG. 6, lever 62 can include a brake face 130 in addition to brake face 78 that enables lever 62 to be a double locking lever. Brake face 130 is disposed on a lower portion 132 of the end of first lever arm 82 that is generally shaped like a piece of pie. First lower arm 82 is wider at lower portion 132 than a widest portion of second lever arm 84. First lever arm 82 is configured so that brake face 130 engages first side face 44 of column 12 when stop pin 68 suffers a malfunction and/or is bent or broken by lever 62 thereby allowing lever 62 to rotate. Brake face 130 does not engage first side face 44 when the brake assembly is unlocked and stop pin 68 has not been bent or broken. Brake face 130 does not engage first side face 44 when brake face 78 engages second side face 46.

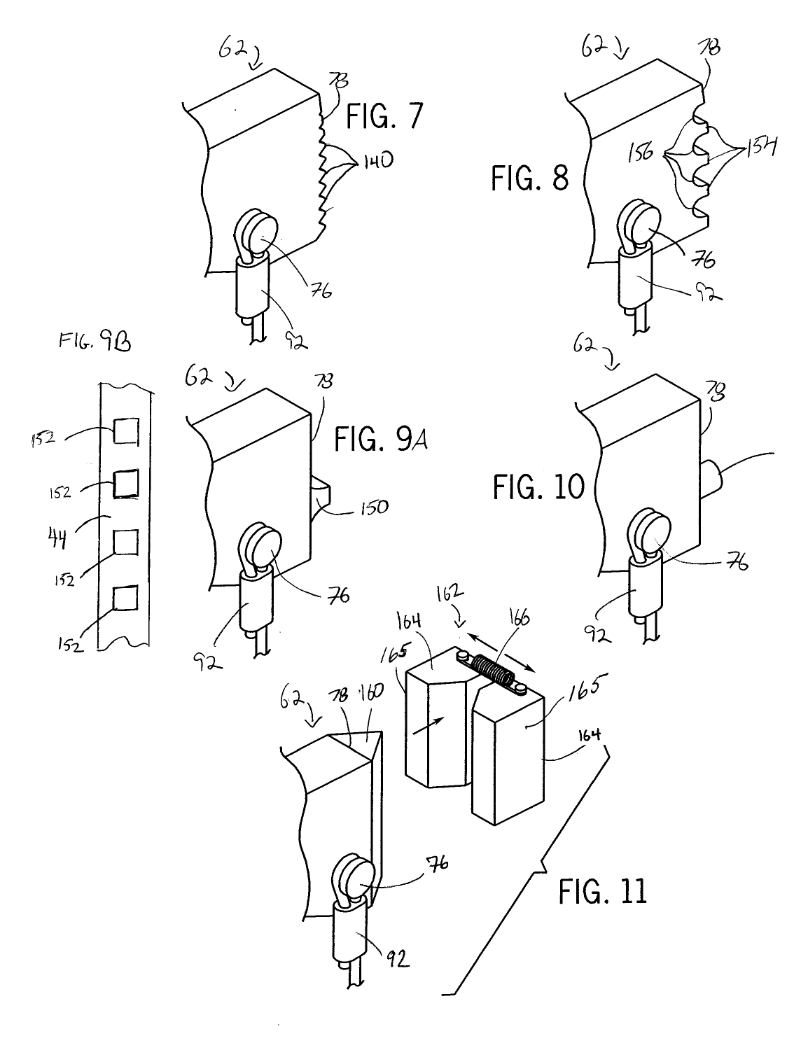

Referring now to FIG. 7, lever 62 includes brake face 78. Brake face 78 can include a plurality of serrated sharp teeth 140 configured to provide a braking force when engaged against second side face 46. Brake face 78 may be made of a hard, aggressive surface such as steel. Brake face 78 can also be made of a tacky or ultra high friction material like ethylene propylene diene monomer (EPDM) or a hard foam that provides sufficient friction to prevent movement of platform assembly 22.

Referring now to FIGS. 8-10, brake face 78 can include teeth configured to mate with mating elements (e.g., openings, formed ridges or a gear rack) formed in or on, or attached to first side face 44. The teeth and mating elements provide the braking force required to halt the platform assembly 22. The mating elements catch the teeth when the brake assembly 24 moves brake face 78 towards the mating elements. FIG. 9A shows brake face 78 that includes a tooth 150 having a rectangular tooth face. FIG. 9B shows first side face 44 of column 12 including rectangular openings 152 sized to catch tooth 150 of FIG. 9A when brake assembly 24 moves tooth 150 towards column 12 (i.e., when the brake assembly 24 is in the locked state). FIG. 8 shows brake face 78 having a plurality of teeth 154 and a plurality of partial cylindrical openings 156. The mating element corresponding to brake face 78 of FIG. 8 can include a plurality of openings sized to catch teeth 154 and/or can include a plurality of partial cylinders configured to be caught by partial cylindrical openings 156. FIG. 10 shows brake face 78 having a tooth that is cylindrical and is configured to be caught in a similar manner as tooth 150 of FIG. 9.

Referring now to FIG. 11, brake face 78 can include a wedge type cam 160 on the end of lever 62 configured to slide along with minimal friction or be positioned near a mating element 162 attached to the platform when brake assembly 24 is locked and unlocked. Wedge 160 can be generally triangular and have two cam faces. Mating element 162 has two brake shoe members 164, each brake member 164 having a face so that mating elements 162 present a split face configured to receive wedge 160 and cam along it. Members 164 are attached to the platform so as to move up and down with the platform but be slidable toward and away from one another within the channel of the column. At least one spring 166 exerts force on the brake members 164 that pulls together the faces 165 of brake members 164 to disengage them from the column when the lever 62 is in the disengaged position, i.e., with full tension on the cables sufficient to overcome the spring (not shown in FIG. 11) that biases lever 62 toward the engaged position. If tension is relieved from the cables(s), brake assembly 24 pivots wedge 160 into engagement with mating element 162 and wedge 160 forces apart brake members 164 so that the outward faces 165 of each brake shoe 164 press against opposing surfaces on the inside of the channel in the column to create a friction force against the column, thereby halting the platform assembly 22.

A second platform assembly could be connected by at least one flexible drive member to platform assembly 22 and/or plate 60. The second platform assembly can be attached to its own brake assembly or the cable from above can be attached to the brake assembly of the lower platform assembly and be used to lift both the lower platform assembly and the upper platform assembly.

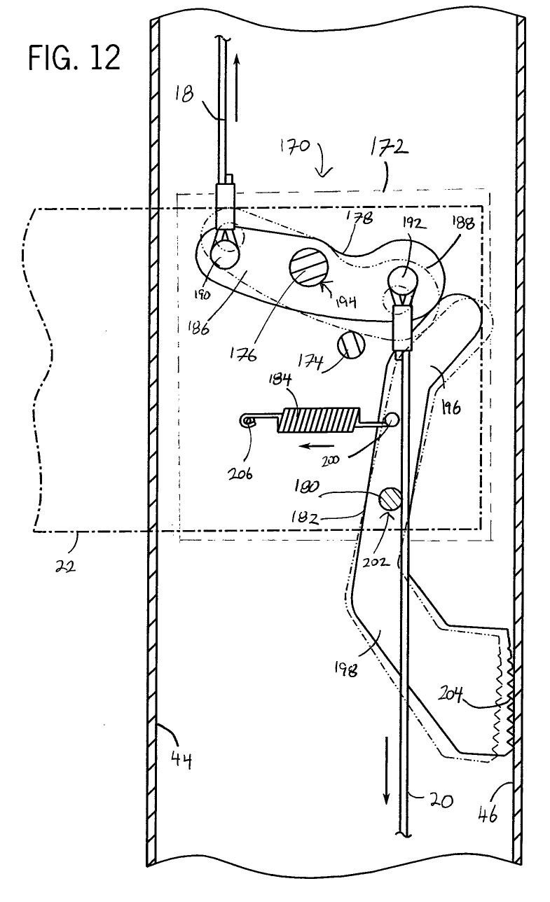

FIG. 12 illustrates an alternate embodiment brake assembly 170 that includes a plate 172, stop pin 174, a first pivot pin 176, first lever 178, a second pivot pin 180, second lever 182 and spring 184. First lever 178 includes a first lever arm 186, a second lever arm 188, a first mounting pin 190, a second mounting pin 192 and a pivot pin opening 194. Second lever 182 includes a first lever arm 196, a second lever arm 198, a spring mount 200, a pivot pin opening 202 and a brake face 204. Spring 184 biases levers 178 and 182 into engaged positions, and the tension on cable 18 (and cable 20 if provided) biases the levers 178 and 182 into disengaged positions.

Plate 172 includes a spring mount 206. Lever arms 186 and 188 of first lever 178 are disposed on opposite sides of pivot pin opening 190. First mounting pin 190 extends from and/or is attached to first lever arm 186. Second mounting pin 188 extends from and/or is attached to second lever arm 188. First pivot pin 176 is fixedly attached to and/or extends from plate 172 and platform assembly 22. First pivot pin 176 extends through pivot pin opening 190 so that first lever 178 can pivot about a pivot axis. First pivot pin 176 can be pivotally attached to first lever 178. Alternatively, pivot pin 176 can be fixedly attached to first lever 178 and pivotally attached to plate 172 and platform assembly 22. Flexible drive members 18 and 20 are attached to first mounting pin 190 and second mounting pin 192, respectively, and can be operated as described above.

Stop pin 174 is attached to and/or extends from plate 190 and/or platform assembly 22. Tension and/or force on flexible drive members 18 and/or 20 causes first lever 178 to rotate (FIG. 12 illustrates clockwise rotation) until first lever engages stop pin 174. Lever arms 196 and 198 of second lever 182 are disposed on opposite sides of pivot pin opening 202. Second pivot pin 180 is fixedly attached to and/or extends from plate 172 and platform assembly 22. Second pivot pin 180 extends through pivot pin opening 202 so that second lever 182 can pivot about a pivot axis that is parallel to the pivot axis of first lever 178. Second pivot pin 180 can be pivotally attached to second lever 182. Alternatively, second pivot pin 180 can be fixedly attached to second lever 182 and pivotally attached to plate 172 and platform assembly 22.

Spring mount 206 is attached to first lever arm 196 by spring 184 which extends between spring mount 200 and spring mount 206, spring 184 exerting a force that can cause second lever 182 to rotate in a direction (FIG. 12 illustrates counterclockwise rotation) toward the engaged position. Spring 184 causes first lever arm 196 to engage second lever arm 188 thereby exerting a force on first lever 178 that can cause first lever 178 to rotate in a direction away from stop pin 174 when flexible drive members 18 and 20 are slack and/or when the moments of the tension forces of flexible drive members 18 and 20 are overcome (i.e., when brake assembly 170 is in a locked state). Brake face 204 is disposed on an end of second lever arm 198 and is configured to engage second side face 46 to provide braking force sufficient to halt platform assembly 22 in the locked state.

Spring 184 biases brake face 204 to engage second side face 46. Forces exerted on first lever 178 by at least one of flexible drive members 18 and 20 can cause first lever 178 to cam against and exert a force on second lever 182 that overcomes the force of spring 206 and causes second lever 182 to rotate so that brake face 204 does not engage second side face 46 thereby allowing platform assembly 22 to be raised and lowered. Like the other embodiments, brake assembly 170 can be configured to operate with a one flexible member system, a two flexible member system, or an endless flexible member system.

It should be appreciated that merely a preferred embodiment of the invention has been described above. However, many modifications and variations to the preferred embodiment will be apparent to those skilled in the art, which will be within the spirit and scope of the invention. Therefore, the invention should not be limited to the described embodiment. To ascertain the full scope of the invention, the following claims should be referenced.

1. A brake assembly for a platform lift for a vehicle, the platform lift comprising at least one platform assembly suspended by at least one flexible drive member and guided by at least one column, the platform assembly being movable vertically by moving the flexible drive member, the brake assembly comprising:
a lever pivotally attached to the platform assembly, the lever being pivotable about a pivot axis and being connected to the at least one flexible drive member so that tension on the flexible drive member rotates the lever about the pivot axis into a disengaged position;
a spring biasing the lever away from the disengaged position toward an engaged position if tension is relieved from the flexible drive member;
a brake connected to the platform assembly so as to move up and down with the platform assembly and configured to engage the column when actuated and to disengage the column when de-actuated, the brake cooperating with the lever so as to be disengaged in the disengaged position of the lever and engaged with the column in the engaged position of the lever.

2. The brake assembly of claim 1, wherein the brake is positioned at an end of the lever.

3. The brake assembly of claim 2, wherein the brake is a friction brake that presses against a surface of the column.

4. The brake assembly of claim 2, wherein the brake is a ratchet brake that arrests downward movement of the platform assembly when at least one tooth of the lever engages a mating element of the column.

5. The brake assembly of claim 1, wherein the brake is a cam operated brake.

6. The brake assembly of claim 1, wherein the brake has at least one brake member connected to the platform that moves into engagement with the column when the lever moves to the engaged position of the lever.

7. The brake assembly of claim 6, wherein there are two brake members connected to the platform and the end of the lever is a cam that wedges between the two brake members to move them into engagement with the column.

8. The brake assembly of claim 5, wherein the brake member is a brake lever that is moved into engagement with the column by a spring when the lever moves to the engaged position.

9. A brake assembly for a platform lift for a vehicle, the platform lift comprising at least one platform assembly suspended by at least one flexible drive member and guided by at least one column having a channel with a channel first face and a channel second face, the platform assembly being movable vertically, the brake assembly comprising:
a plate attached to the platform assembly and positioned within the channel;
a lever pivotally attached to the plate, the lever pivotable about a pivot axis and having a first lever arm and a second lever arm disposed on opposite sides of the pivot axis;
a first coupling mount attached to the first lever arm and connected to the at least one flexible drive member;
a first stop pin attached to the plate configured to engage the lever when the lever is rotated by a force provided by the at least one flexible drive member, the lever transmitting the force to the platform assembly through the first stop pin and plate when the lever engages the first stop pin;
a first brake face disposed on an end of the second lever arm; and
a spring attached between the plate and the lever, the spring configured to rotate the lever so as to force the first brake face against the channel first face thereby providing a braking force when the at least one flexible drive member is slack.

10. The brake assembly of claim 9; wherein a second coupling mount is attached to the second lever arm and connected to another at least one flexible drive member.

11. The brake assembly of claim 10, wherein the spring is configured to rotate the lever so as to force the first brake face against the channel first face thereby providing a braking force when the at least one flexible drive member and the another at least one flexible drive member are stationary and tensioned

12. The brake assembly of claim 10, wherein the at least one flexible drive member and the another at least one flexible drive member are part of an endless flexible drive member system.

13. The brake assembly of claim 9, wherein a second stop pin is attached to the plate and is configured to engage the lever when the first stop pin is engaged by the lever.

14. The brake assembly of claim 9, wherein the brake face comprises a plurality of serrated teeth.

15. The brake assembly of claim 9, wherein the brake face comprises at least one tooth and the channel first face includes a plurality of mating elements configured to catch the at least one tooth to brake the platform assembly.

16. The brake assembly of claim 9, wherein the brake face comprises a wedge, and the channel first face includes a split-face mating element configured to be forced apart by the wedge thereby creating a frictional force with the wedge.

17. The brake assembly of claim 9, wherein a second brake face is disposed on an end of first lever arm and is configured to engage the channel second face when the first brake face engages the channel first face.

18. The brake assembly of claim 9, wherein a second brake face is disposed on an end of first lever arm and is configured to engage the channel second face when the stop pin has been damaged.

19. A brake assembly for a platform lift for a vehicle, the platform lift comprising at least one platform assembly suspended by at least one flexible drive member and guided by at least one column having a channel with a channel first face, the platform assembly being movable vertically, the brake assembly comprising:
a plate attached to the platform assembly and positioned within the channel;
a first lever pivotally attached to the plate, the first lever pivotable about a first lever pivot axis and having a first lever arm and a second lever arm disposed on opposite sides of the first lever pivot axis;
a second lever pivotally attached to the plate, the second lever pivotable about a second lever pivot axis and having a third lever arm and a fourth lever arm disposed on opposite sides of the second lever pivot axis;
a first coupling mount attached to the first lever arm and connected to the at least one flexible drive member;
a first brake face disposed on an end of the fourth lever arm;
a spring attached between the plate and the third lever arm, the spring configured to rotate the second lever so as to force the second lever into engagement with the first lever thereby rotating the first lever, and further configured to force the first brake face against the channel first face thereby providing a braking force when the at least one flexible drive member is slack; and
a first stop pin attached to the plate configured to engage the first lever when the first lever is rotated by a drive member force provided by the at least one flexible drive member, the first lever causing the second lever to rotate so as to move the first brake face away from the channel first face, and the first lever transmitting the drive member force to the platform assembly through the first stop pin and plate when the first lever is in engagement with the first stop pin.

20. The brake assembly of claim 19, wherein the first lever pivot axis is parallel to the second lever pivot axis.

21. The brake assembly of claim 19, wherein a second coupling mount is attached to the second lever arm and connected to another at least one flexible drive member.

22. The brake assembly of claim 21, wherein the at least one flexible drive member and the another at least one flexible drive member are part of an endless flexible drive member system.
